(19) United States
(12) Patent Application Publication
(10) Pub. No.: US 2018/0285985 A1
(43) Pub. Date: Oct. 4, 2018

(54) CUSTOMIZING CONTENT BY FILTERING A MATRIX OF TEMPORAL VALUES

(71) Applicant: Facebook, Inc., Menlo Park, CA (US)

(72) Inventors: Ido Wakrat, London (GB); Tao Cui Baecklund, San Jose, CA (US); Juan Felipe Coirolo Testa, London (GB); Dmitry Koterov, Redwood City, CA (US)

(21) Appl. No.: 15/476,725

(22) Filed: Mar. 31, 2017

(51) Int. Cl. G06Q 50/00; G06N 99/00; G06N 7/00

(52) U.S. Cl. CPC G06Q 50/01; G06N 7/005; G06N 99/005

(57) ABSTRACT

An online system customizes content items by processing a matrix of temporal values using different types of filters. A temporal filter filters the matrix using time-based parameters such as start dates and end dates of the temporal values. An action filter filters the matrix using actions performed by the users and may also generate a likelihood that a user will interact with a content item including a selected temporal value. A category filter filters the matrix using user profile information of the users received by the online system. Users may be more likely to interact with content items selected by the online system using the filtering process because the content items include temporal values or other information that are customized to preferences of particular users. For example, the customized content items include information describing lodgings that the users are likely to select.

### BACKGROUND

This disclosure generally relates to customizing content on an online system and particularly to customizing content items by filtering a matrix of temporal values.

An online system typically has access to large amounts of content that may be of interest to other users of the online system. Because of the increasing popularity of these types of online systems and the increasing amount of user-specific information maintained by such online systems, an online system provides an ideal forum to increase awareness about content items to online system users. Existing systems can select content items, for instance, using a textual analysis to determine content items including content that matches the interests of users of the system. However, existing systems do not select content items based on temporal values, or in other words, content items including information that changes in value based on time. Additionally, at a large scale of information, it is difficult and challenging to efficiently process content items to select specific content items in which a given user is most likely interested and with which the user is likely to interact.

### SUMMARY

An online system customizes content items by processing a matrix of temporal values using different types of filters. A temporal filter filters the matrix using time-based parameters such as start dates and end dates of the temporal values. An action filter filters the matrix using actions performed by the users and may also generate a likelihood that a user will interact with a content item including a selected temporal value. A category filter filters the matrix using user profile information of the users received by the online system. By filtering the matrix of temporal values, the online system can process temporal values more effectively than existing systems that, for example, process temporal values by ranking based on given metric such as the magnitude of the temporal values. Users may be more likely to interact with content items selected by the online system using the filtering process because the content items include temporal values or other information that are customized to preferences of particular users.

In one embodiment, an online system receives, from a third party system, a matrix of temporal values for a plurality of lodgings. Each of the temporal values corresponds to at least a start date and an end date. The online system also receives one or more parameters describing the plurality of lodgings from the third party system. A target start date and a target end date (e.g., start date for a lodging stay and end date for the lodging stay) for a user of the online system are determined in response to at least one action performed by the user. A subset of temporal values is determined by filtering the matrix for temporal values having a corresponding start date and corresponding end date matching the target start date and the target end date, respectively (e.g., having availability corresponding to the start and end dates). A subset of lodgings of the plurality of lodgings is determined, where each lodging of the subset of lodgings corresponds to at least one of the subset of temporal values. Lodging preferences of the user are determined based on actions performed by the user on the online system or the third party system. For each lodging of the subset of lodgings, a likelihood that the user will select the lodging is generated by matching the lodging preferences of the user with the corresponding one or more parameters of the lodging. A lodging of the plurality of lodgings is selected based on the generated likelihoods. A content item is provided for presentation on a client device of the user. The content item includes the corresponding temporal value of the subset of temporal values of the selected lodging.

### BRIEF DESCRIPTION OF DRAWINGS

Figure (FIG. 1 is a diagram of a system environment for customizing content items by filtering a matrix of temporal values according to one embodiment.

FIG. 2 is a block diagram illustrating the system architecture of an online system according to one embodiment.

FIG. 3A is a data flow diagram of a temporal filter of the online system according to one embodiment.

FIG. 3B is a data flow diagram of an action filter and a category filter of the online system according to one embodiment.

FIG. 4 is a flowchart illustrating a process for customizing content items according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

FIG. 1 is a diagram of a system environment for customizing content items by filtering a matrix of temporal values according to one embodiment. The system environment includes an online system 100, a client device 110, and one or more third party systems 120, connected to each other via a network 130. In other embodiments, different and/or additional entities can be included in the system environment.

The online system 100 allows users of the online system 100 to communicate or otherwise interact with each other and access content. The online system 100 receives information about the users, for example, user profile information and information about actions performed by users on the online system 100 or a third party system 120. The online system 100 also provides content items based on the information about the users or information from third party systems 120. The online system 100 can customize the content items for particular users by selecting content items using one or more types of filters, e.g., a temporal filter, an action filter, or a category filter. For instance, the online system 100 uses a temporal filter to filter temporal values corresponding to content items. By filtering content items, the online system 100 can efficiently select subsets of content items that are customized for particular users. Accordingly, the online system 100 provides a more engaging user experience because the particular users are more likely to interact with the customized content items.

In some embodiments, the online system 100 is a social networking system. Users join the social networking system and add connections to other users to which they desire to be connected. At least some of these connections may be considered “friendship” type connections. Users of the social networking system may provide information about themselves, which is stored as user profiles. For example, users may provide their age, gender, geographical location, educational history, employment history and/or the like. The information provided by users may be used by the social networking system to direct information to the user. For example, the social networking system may recommend social groups, events, other social networking objects, and potential connections (e.g., friends) to a user. A social networking system may also enable users to explicitly express interest in objects and/or concepts, such as brands, products, celebrities, hobbies, sports teams, music, and the like. These interests may be used in a myriad of ways, including targeting content items and personalizing the user experience on the social networking system by showing relevant stories about other users of the social networking system based on shared interests.

In some embodiments, the online system 100 maintains and stores a social graph. The social graph includes nodes connected by a set of edges. Nodes represent users and other objects of the online system 100, such as web pages embodying concepts and entities, and edges connect the nodes. Each edge represents a particular interaction or connection between two nodes, such as a user expressing an interest in a news article shared by another user. As another example, an edge may represent a connection (e.g., a friendship type relationship) established between two users. As such, the social graph includes data representative of the social signals of the social networking system. In one embodiment, the online system 100 generates the edges of the social graph based on the observed actions of its users.

The client device 110 is a computing device capable of receiving user input as well as transmitting and/or receiving data via the network 130. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 130. In one embodiment, a client device 110 executes an application allowing a user of the client device 110 to interact with the online system 100 or a third party system 120. For example, a client device 110 executes a browser application to enable interaction between the client device 110 and the online system 100 via the network 130. In another embodiment, a client device 110 interacts with the online system 100 through an application programming interface (API) running on a native operating system of the client device 110, such as IOS® or ANDROID™.

In one embodiment, a third party system 120 is an application provider communicating information describing applications for execution by a client device 110 or communicating data to client devices 110 for use by an application executing on the client device 110. In other embodiments, a third party system 120 provides content or other information for presentation via a client device 110. Each third party system 120 has a server outside of the domain of the online system 100. In one embodiment, the third party system 120 communicates content (e.g., content items, a website, or HTML code) from a server of the third party system 120 to a server of the online system 100. The content may be created by the entity that owns the third party system 120. Such an entity may be a company or other type of organization offering a product (e.g., a tangible object or an intangible service such as lodging or transportation), or message that the company wishes to promote.

The network 130 includes any combination of local area and/or wide area networks, using both wired and/or wireless communication systems. In one embodiment, the network 130 uses standard communications technologies and/or protocols. For example, the network 130 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

### II. Example System Architecture of Online System

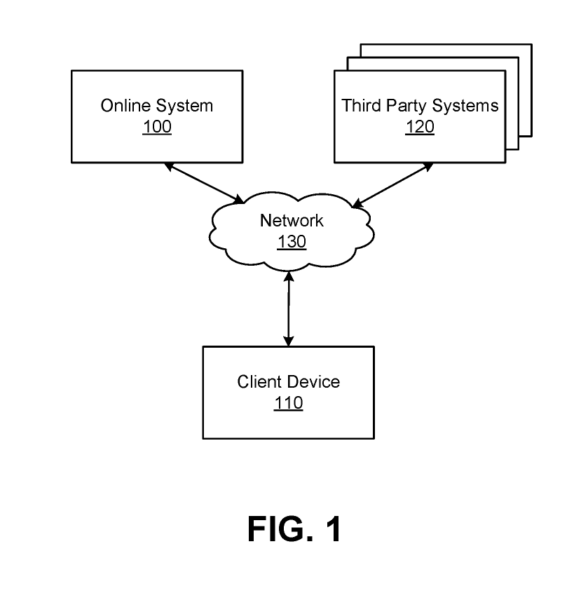

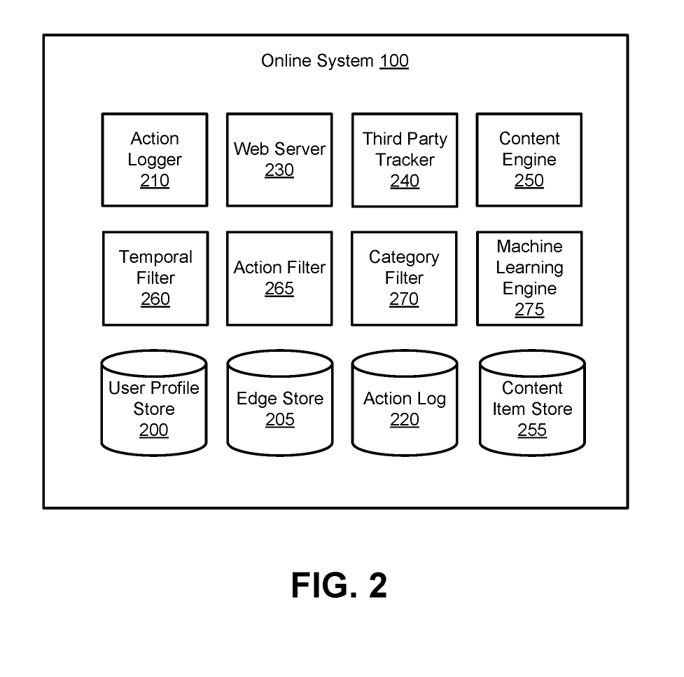

FIG. 2 is a block diagram illustrating the system architecture of the online system 100 according to one embodiment. The online system 100 includes a user profile store 200, action logger 210, action log 220, edge store 225, web server 230, third party tracker 240, content engine 250, content item store 255, temporal filter 260, action filter 265, category filter 270, and machine learning engine 275. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

The user profile store 200 stores user profiles of users of the online system 100. A user profile includes declarative information about the user that was explicitly shared by the user and may also include profile information inferred by the online system 100. In one embodiment, a user profile includes multiple data fields, each describing one or more attributes of the corresponding user of the online system 100. Examples of information stored in a user profile include biographic, demographic, and other types of descriptive information, such as number of family members, travel history, number and types of pets, membership of organizations (e.g., American Automobile Association (AAA), loyalty programs of third party systems 120, government organizations, veteran or military groups, or senior citizen groups), occupation, geographical location, educational history, gender, hobbies or preferences, and the like.

A user profile may also store other information provided by the user, for example, images or videos. In certain embodiments, images of users may be tagged with identification information of users of the online system 100 displayed in an image. A user profile in the user profile store 200 may also maintain references to actions by the corresponding user performed on the online system 100. The user profile store 200 further stores data describing one or more relationships between different users and allows users to specify their relationships with other users. For example, these user-defined relationships allow users to generate relationships with other users that parallel the user's real-life relationships, such as friends, co-workers, partners, and the like.

The user profile store 200 can store user profiles of individuals, as well as user profiles of entities such as companies or organizations, e.g., that own a third party system 120. This allows an entity to establish a presence on the online system 100 for connecting and exchanging content with other users of the online system 100. The entity may post information about itself, about items provided by the entity, for example, products or services offered by the entity, or provide other information to users of the online system 100 using a brand page of the entity's user profile. Users of the online system 100 may connect to the brand page to receive information posted to the brand page or to receive information from the brand page. A user profile of the brand page may include information about the entity itself, providing users with background or informational data about the entity.

The action logger 210 receives communications about user actions internal to and/or external to the online system 100, populating the action log 220 with information about user actions. Examples of actions include adding a connection to another user, sending a message to another user, uploading an image, reading a message from another user, viewing content provided by another user, attending an event posted by another user, among others. In addition, a number of actions may involve an object and one or more particular users, so these actions correspond to those users as well and stored in the action log 220.

The action log 220 may be used by the online system 100 to track user actions on the online system 100, as well as actions on third party systems 120 that communicate information to the online system 100. Users may interact with various objects on the online system 100 or a third party system 120, and the action logger 210 stores information describing these interactions in the action log 220. Examples of interactions with objects include: interacting with a content item, viewing a brand page of a third party system 120, booking transportation or lodging for a trip, requesting certain amenities for a lodging, checking-in to or checking-out of physical locations (e.g., a lodging, airport, or other type of transit station) via a client device 110, expressing a preference for an object (“liking” the object).

Additionally, the action log 220 may record a user's interactions with content (e.g., sponsored or non-sponsored content) on the online system 100 as well as with other applications operating on the online system 100 or a third party system 120. In some embodiments, data from the action log 220 is used to infer interests or preferences of a user, augmenting the interests included in the user's user profile and allowing a more complete understanding of user preferences. The action log 220 can record information about client devices 110 that a user uses to interact with the online system 100. For example, the action log 220 records whether the user used a laptop computer or smartphone client device 110 to interact with the online system 100. Further, the action log 220 may include information about the types of client devices 110, e.g., smartphone running an IOS® or ANDROID™ operating system.

The action log 220 may also store user actions performed on a third party system 120, such as an external website or via a client device 120, and communicated to the online system 100. For example, the external website may recognize a user of an online system 100 through a social plug-in enabling the external website to identify the user of the online system 100. Since users of the online system 100 are uniquely identifiable, external websites may communicate information about a user's actions outside of the online system 100 to the online system 100 for association with the user. Hence, the action log 220 can record information about actions that users perform on a third party system 120 including webpage viewing histories, content that were engaged, acquisitions made, and other patterns from past actions. The action log 220 can also store information about user actions performed on a third party system 120 received from the third party tracker 240, which is further described below.

In one embodiment, the edge store 225 stores information describing connections between users and other objects on the online system 100 as edges. Edges may be defined by users, allowing users to specify their relationships with other users, e.g., that parallel the users' real-life relationships such as friends, co-workers, family members, etc. The action logger 210 may generate edges when users interact with objects in the online system 100, e.g., expressing interest in a page on the online system 100, sharing a link with other users of the online system 100, and commenting on posts made by other users of the online system 100.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 100, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

In one embodiment, the edge store 225 stores information about edges, such as affinity scores for objects, interests, and other users. Affinity scores, or “affinities,” may be computed by the online system 100 over time to approximate a user's interest in an object or in another user in the online system 100 based on the actions performed by the user. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 200, or the user profile store 200 may access the edge store 225 to determine connections between users.

The web server 230 links the online system 100 via the network 130 to the client devices 110 and third party systems 120. The web server 230 serves web pages, as well as other web-related content, such as JAVA®, FLASH®, XML and so forth. The web server 230 may receive and route messages between the online system 100, client devices 110, and third party systems 120, for example, instant messages, queued messages (e.g., email), text messages, short message service (SMS) messages, or messages sent using any other suitable messaging technique. A user may send a request to the web server 230 to upload information (e.g., images or videos) that are stored in the user profile store 200. Additionally, the web server 230 may provide application programming interface (API) functionality to send data directly to native client device operating systems, such as IOS®, ANDROID™, WEBOS® or RIM®.

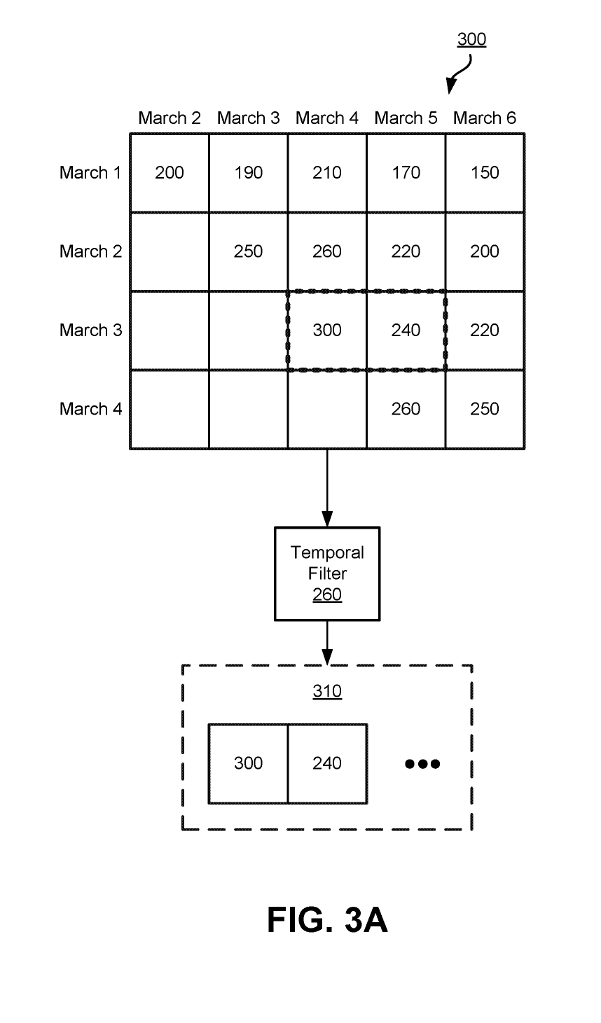

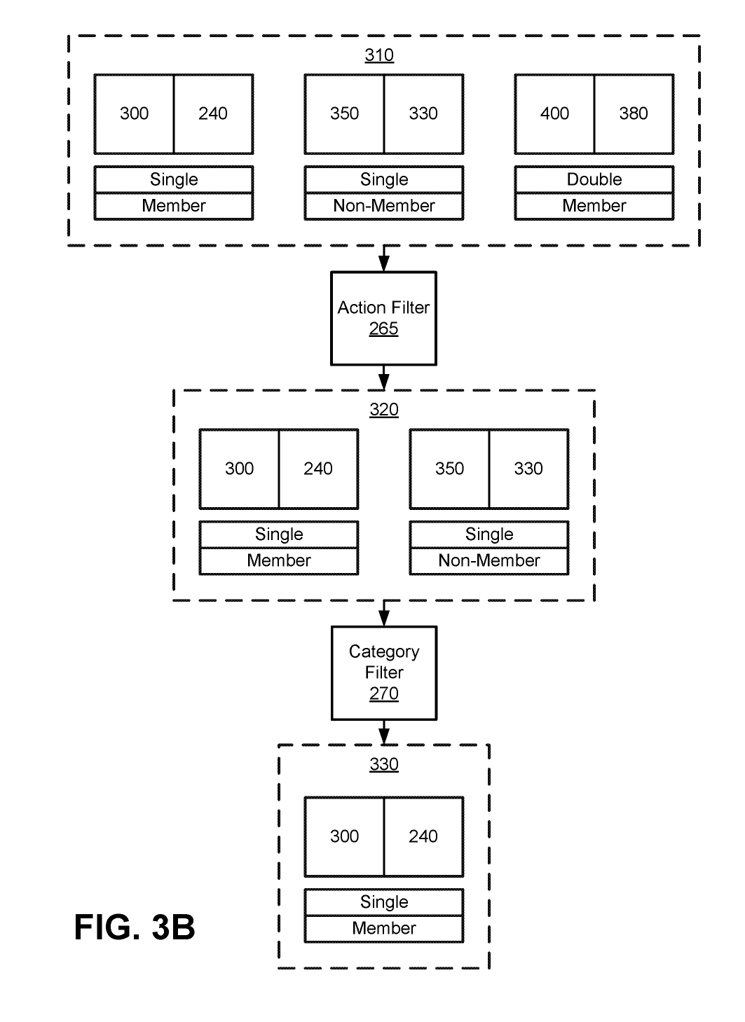

The third party tracker 240 receives third party information from third party systems 120 and stores the received information in the user profile store 200, action log 220, value data store 255, or any other suitable database. In one embodiment, the third party tracker 240 receives, from a third party system 120, a matrix of temporal values and information describing lodging available via the third party system 120. Each of the lodgings correspond to at least one of the temporal values. A temporal value may be broken down into sub-values, e.g., a base value or a values for fees according to local commercial policies or regulations, such as a base price for a hotel room. The information describing the lodging may include parameters that indicate, e.g., a type of a lodging, a geographical location of the lodging, or amenities of a lodging. The third party tracker 240 may also receive parameters describing the temporal values, e.g., indicating a category (e.g., of a user booking lodging) corresponding to a given temporal value. The third party tracker 240 may receive matrices of temporal values that are valid for a predetermined window of time (e.g., a number of months or days). Further, the third party tracker 240 may receive updated temporal values or parameters due to changes in availability of lodgings, or if the window of time for another matrix expires. The online system 100 may also determine or infer parameters describing the lodgings or temporal values from sources other than third party systems 120. An example matrix of temporal values and associated parameters is further described below with reference to FIGS. 3A-B.

In some embodiments, the third party tracker 240 receives information from third party systems 120 using pixel tracking. The third party tracker 240 provides a pixel to a third party system 120 to be included in a user interface of the third party system 120. The third party system 120 provides third party information to the third party tracker 240 in response to a user of the online system 100 viewing the pixel of the user interface. For example, the pixel is included in a user interface displaying a website of the third party system 120, e.g., a website for a process for acquiring a product or service available via the third party system 120 such as booking transportation or lodging for a trip. When the client device 110 of the user displays the pixel of the website on the display screen of the client device, the third party system 120 provides third party information to the third party tracker 240 indicating that the user viewed the website. Additionally, the third party information describes the information about the product or service, and may indicate that the user was close to completing a booking of a lodging or transportation but has not yet completed the booking. In addition to pixel tracking, the third party tracker 240 can also receive user information from cookies (also known as web cookies, Internet cookies, or browser cookies) of client devices 110.

The content engine 250 provides content items for presentation on client devices 110 to users of the online system 100. The content engine 250 may generate content items and store the content items in the content item store 255. The content engine 250 may also retrieve previously generated content items from the content item store 255 or any other source of content items accessible to the online system 100. The content engine 250 can analyze information stored in the user profile store 200, action log 220, or other components of the online system 100, to identify information useful for generating content items.

In some embodiments, one or more content items included in the content item store 255 include sponsored content for presentation to a user and a corresponding amount of compensation. The sponsored content is text, image, audio, video, or any other suitable data presented to a user, and may be provided by a third party system 120. For example, a sponsored content item may be an advertisement. In various embodiments, the sponsored content also specifies a page of content, e.g., a landing page specifying a network address of a webpage. In some embodiments, the amount of compensation is provided by a third party system 120 (providing the corresponding content item) to the online system 100 if content in the content item is presented to a user, if the content in the content item receives a user interaction when presented, if the user completes a booking for lodging via a webpage (or an application) of the third party system 120, or if any other suitable condition is satisfied when content in the content item is presented to a user.

In some embodiments, the compensation provided by a third party system 120 for a content item is proportional to a score determined by the content engine 250. The content engine 250 determines the score based on previous bookings of lodging performed by the user, e.g., according to action information retrieved from the action log 220. For example, the score is greater if the user frequently books lodgings, e.g., within a given duration of time such as the past month or year. Additionally, the score may be proportional to the temporal values of previously booked lodgings of the user.

In an example use case, the content engine 250 selects content items including information describing lodging available by third party systems 120. The content engine 250 selects the content items by filtering temporal values of the lodgings using one or more filters, e.g., the temporal filter 260, action filter 265, or category filter 270. The temporal filter 260 filters temporal values based on one or more target dates or other temporal parameters. The action filter 265 filters temporal values based on actions performed by users of the online system 100. The action filter 265 can determine lodging preferences of a user based on the actions performed by the user. Further, the action filter 265 can generate likelihoods that the user will select a lodging by matching the lodging preferences to parameters of the available lodgings or corresponding temporal values. The category filter 270 filters temporal values based on user profile information of users of the online system 100. The filters are further described below with reference to FIGS. 3A-B. A content item selected by the content engine 250 may include information describing the corresponding lodging and temporal value. In response to changes in temporal values provided by third party systems 120, the content engine 250 can modify a temporal value of a selected content item. The content engine 250 may also dynamically update the selected content item to include the modified temporal value.

In some embodiments, the machine learning engine 275 uses machine learning techniques to train one or more models to generate likelihoods that a given user will select a lodging. The online system 100 may use the models in addition or alternatively to the action filter 265 to generate the likelihoods. Machine learning techniques include, for example, linear regression, decision trees, support vector machines, classifiers (e.g., a Naive Bayes classifier), gradient boosting, neural networks, deep learning, etc. The machine learning engine 275 trains models using feature vectors derived from actions performed by users of the online system 100 (e.g., information describing previous bookings of lodgings retrieved from the action log 220). In some embodiments, the machine learning engine 275 uses the training labels to partition information into positive and negative feature vectors for training sets. For example, positive feature vectors describe lodgings and temporal values of content items that were interacted with by a user, while negative feature vectors describe content items that were presented to users but not interacted with by a user. Thus, the models can predict types of lodgings and temporal values by learning based on the context of lodgings booked by other users of the online system 100.

### III. Example Filters

FIG. 3A is a data flow diagram of the temporal filter 260 of the online system 100 according to one embodiment. The online system 100 receives a matrix 300 of temporal values for a lodging available via a third party system 120. In the example shown in FIG. 3A, each row of the matrix 300 represents a start date and each column of the matrix represents an end date. For instance, a user plans to check-in at the lodging on the start date and check-out of the lodging on the end date. In other embodiments, the matrix 300 may have any number of rows or columns, or other numbers of dimensions (e.g., a 3D matrix). Additionally, the dimensions may represent parameters other than start date and end date, e.g., duration of stay at the lodging, a certain check-in or check-out time, or a type of the lodging (e.g., single, double, suite).

The temporal values of the matrix 300 each have a corresponding start date and end date. For example, the temporal value of 200 corresponds to the start date of March 1 and the end date of March 2. The temporal value may indicate an amount of compensation that a user staying at the lodging provides to the third party system 120. For instance, a user who checks into the lodging on March 1 and checks out of the lodging on March 2 provides 200 units of given currency (e.g., United States Dollars or British Pounds) to the third party system 120 in return for the lodging for that night (or day). The temporal values may depend on the number of nights (or days) that a user stays at the lodging. For example, the temporal value may decrease for subsequent (e.g., consecutive) days of a stay at the lodging. The temporal values may also depend on the capacity or demand of the lodging on a particular day. Typically, temporal values are greater on weekends, holidays, or other days that coincide with events such as a sporting game, music concert, or convention occurring nearby the lodging. Not all combinations of start dates and end dates of the matrix 300 may have a corresponding temporal value because a user may not check out on the same date as, or prior to, the check-in date.

In an example use case, the content engine 250 determines a target start date of March 3 and a target end date of March 5 of a trip for a user. The content engine 250 may determine the target dates based on information from the action log 220, e.g., online searches performed by the user indicating target dates to travel destinations, acquiring transportation for the target dates, or scheduling meetings or events around the target dates. The content engine 250 may also determine the target dates based on identifying combinations of target start and end dates having lower temporal values relative to other temporal values in the matrix 300. The temporal filter 260 filters the temporal values of the matrix 300 by selecting the temporal values corresponding to the target start date of March 3 and the target end date of March 5. Though FIG. 3A shows one matrix 300, the temporal filter 260 can filter temporal values of one or more matrices each corresponding to a lodging. The online system 100 may receive multiple matrices from any number of different third party systems 120. The temporal filter 260 determines a subset 310 of temporal values from the filtered one or more matrices. In this example, the subset 310 includes the pair of temporal values of 300 and 240, which correspond to a check-in date of March 3 and a check-out date of March 5. In particular, the temporal values for staying at the lodging on the nights of March 3 and March 4 are 300 and 240, respectively. In some embodiments, the temporal filter 260 (or any other filter) may aggregate temporal values for stays greater than one night or day.

FIG. 3B is a data flow diagram of the action filter 265 and the category filter 270 of the online system 100 according to one embodiment. Following in the example described in FIG. 3A, the temporal filter 260 determines additional temporal values to be included in the subset 310 by filtering additional matrices received from third party systems 120. The temporal values have parameters (not shown previously in FIG. 3A) that describe the temporal values or the corresponding lodging of the temporal values. For example, the parameters shown in FIG. 3B indicate an occupancy (e.g., number of beds) of the lodging and whether the user booking the lodging needs to be a member (e.g., a loyalty member of a hotel or given organization) to be eligible for the temporal value. In particular, the parameters of the temporal values 300 and 240 indicate that the corresponding lodging has single occupancy and that the user needs to be a member, the parameters of the temporal values 350 and 330 indicate that the corresponding lodging has single occupancy and that the user does not need to be a member, and the parameters of the temporal values 400 and 380 indicate that the corresponding lodging has double occupancy and that the user needs to be a member. Typically, the temporal values are greater for lodgings with larger occupancy and are greater for non-members relative to members.

The action filter 265 determines a subset 320 of temporal values by filtering the subset 310 of temporal values. For example, the content engine 250 determines a subset of the lodgings corresponding to the temporal values of the subset 310. For each of the lodgings in the subset, the action filter 265 determines a likelihood that the user will want to book the lodging. The action filter 265 filters the subset 310 using the generated likelihoods. In some embodiments, the action filter 265 ranks the filtered subset 320 based on the likelihoods and uses the ranking to determine alternative lodgings if a top ranked lodging (i.e., corresponding to the temporal value having the greatest likelihood of being selected by a user) becomes unavailable.

In one embodiment, the action filter 265 determines an expected number of people that the user will stay with at a lodging. For instance, the action filter 265 retrieves information from the action log 220 or user profile store 200 indicating a number of family members of the user, e.g., based on actions performed by the user to add connections to the family members on the online system 100 or update the user profile of the user. As another example, the action filter 265 retrieves action information from the action log 220 indicating a number of people that the user stayed with at a lodging for one or more previous trips. The action filter 265 generates a likelihood that the user will select a lodging based on whether the lodging has an occupancy that accommodates the expected number of people staying with the user (e.g., a travel preference). For example, the action filter 265 determines the expected number of people is one (i.e., the user is lodging by herself or himself). Thus, the action filter 265 determines a greater likelihood that the user will stay at a lodging with a single occupancy instead of a double occupancy. The action filter 265 determines a subset 320 by excluding temporal values of lodgings that have likelihoods less than a threshold value. In this example, the action filter 265 excludes the temporal value pair of 400 and 380, and includes the temporal value pairs of 300 and 240, and 350 and 330, because the latter two are associated with lodgings that have single occupancy, while the former one is associated with lodging that has double occupancy.

In some embodiments, the action filter 265 filters temporal values based on other types of parameters. For example, the action filter 265 determines amenities (e.g., wireless Internet, free breakfast, room service, an indoor or outdoor pool or spa, a Jacuzzi, a gym, vending machines, airport shuttle, pet accommodation, laundry, rollaway bed, etc.) that the user may want at the lodging. The action filter 265 may determine the amenities (e.g., travel preferences) based on amenities previously selected by the user (or available) for a past stay at a lodging. As another example, based on information from the action log 220 indicating that the user frequently exercises and swims, the action filter 265 determines that the user will likely want recreational amenities such as a pool and a gym at the lodging. As yet another example of travel preferences, based on information from the action log 220 indicating that the user posts photos of a pet dog, the action filter 265 determines that the user will likely want a lodging that accommodates small pets (e.g., a room with hardwood flooring instead of carpet). In some embodiments, the action filter 265 generates a likelihood for a lodging that is proportional to the number of the user's desired amenities that match the available amenities of the lodging.

As another example of travel preferences, the action filter 265 determines that user booked transportation to a geographical location on a first date and transportation from the geographical location on a second date. The action filter 265 determines that the first date and the second date match the target start and end dates (e.g., check-in and check-out dates) of the user for a trip, respectively. Thus, the action filter 265 determines that the user likely wants to book lodging at the geographical location for the trip. Accordingly, the action filter 265 generates greater likelihoods for lodgings at the geographical location, e.g., as indicated by the parameters of the lodgings.

The category filter 270 determines a subset 330 of temporal values by filtering the subset 320 of temporal values, in some embodiments. The category filter 270 retrieves information from the user profile store 200 (or the action log 220) to determine one or more categories of the user. For example, the category filter 270 determines that the user is a member of a loyalty program of a third party system 120 (e.g., an international hotel chain). The category filter 270 filters the subset 320 by matching the determined categories of the user to categories of the temporal values, as indicated by the parameters of the temporal values. For example, the category filter 270 excludes the pair of temporal values 350 and 330 because the corresponding parameters indicate that the temporal values are for non-member users. On the other hand, the category filter 270 includes the pair of temporal values 300 and 240 in the subset 330 because the corresponding parameters indicate that the temporal values are for members of the loyalty program. The content engine 250 may select a lodging corresponding to temporal value(s) of the subset 330 (e.g., based on the generated likelihoods), and the content engine 250 provides one or more content items including information describing the selected lodging or corresponding temporal value(s).

Though the example in FIG. 3B shows the action filter 265 and category filter 270 filtering three pairs of temporal values to one pair of temporal values, in practice, the online system 100 can use one or more of the filters to efficiently filter large volumes (e.g., thousands to hundreds of thousands or more) of temporal values from matrices received by third party systems. At large scale, generating likelihoods that a user will book a lodging for different combinations of start dates and end dates may be resource intensive (e.g., requiring heavy use of processing or memory resources). However, the online system 100 reduces the resources required to process the temporal values by filtering using the start dates and end dates (or other types of temporal parameters such as duration of stay at a lodging), as well as the previously described parameters of the lodgings or temporal values. Thus, the filters of the online system 100 provide a technical advantage.

Furthermore, by filtering the temporal values, the online system 100 can customize content items to present information of lodging that users are more likely to interact with. Since the online system 100 receives compensation from third party systems 120 based on user interactions with content items (e.g., including content provided by the third party systems 120), customizing the content items may increase the compensation received by the online system 100. In an example of booking lodgings, existing systems may rank lodgings only based on the magnitude of values of the lodgings and provide the lodgings with the lowest value (e.g., most affordable) to users. However, users may not necessarily want to book the lodging with the lowest value. Rather, users are more likely to book lodgings that have been customized to their particular travel preferences, even though the corresponding temporal value may not be the lowest in magnitude among a matrices of temporal values received by third party systems 120.

When a user becomes available to receive a content item, the online system 100 can use one or more matrices of temporal values and information that the online system 100 has stored about the user (e.g., from the user profile store 200, stored activities on the online system 100, stored activities from a third party system 120 received via a pixel fire or an online system 100 API for a mobile application) to dynamically customize the content item to the user. The online system 100 can present a content item for a lodging that is relevant for the user (e.g., has the right geographical location, has the amenities desired, and/or still has availability on the relevant dates), that has the type of lodging (e.g., room or suite) that is sized to fit the user's family and accounts for the user's preference in lodging type (e.g., one king bed over two queen beds), and/or that provides a temporal value (e.g., price) specific to the user (e.g., accounting for the travel start and/or end dates, for the particular lodging type, for any extra lodging amenities, for the fact that the user is in the hotel loyalty program or should receive other particular incentives, etc.). A different user searching for the same lodging might receive a content item showing a different lodging type, or same lodging but different temporal value.

### IV. Example Process Flow

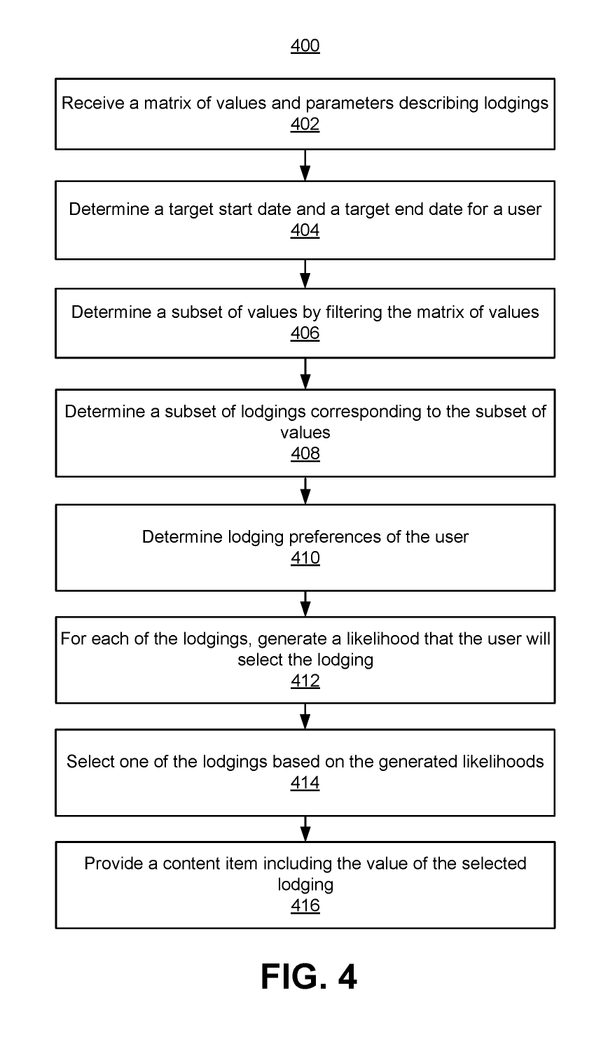

FIG. 4 is a flowchart illustrating a process 400 for customizing content items according to one embodiment. In some embodiments, the process 400 is performed by the online system 100—e.g., modules of the online system 100 described with reference to FIG. 2—within the system environment in FIG. 1. The process 400 may include different or additional steps than those described in conjunction with FIG. 4 in some embodiments or perform steps in different orders than the order described in conjunction with FIG. 4.

In one embodiment, the third party tracker 240 receives 402 a matrix of temporal values for a set of lodgings from a third party system 120, where each temporal value of the matrix corresponds to at least a start date and an end date. The third party tracker 240 also receives one or more parameters describing the set of lodgings. The content engine 250 determines 404 a target start date and a target end date for a user of the online system 100 responsive to at least one action performed by the user, e.g., on the online system 100 or the third party system 120.

The temporal filter 260 determines 406 a subset of temporal values by filtering the matrix for temporal values having a corresponding start date and corresponding end date matching the target start date and the target end date, respectively. The content engine 250 determines 408 a subset of the set of lodgings, where each lodging of the subset of lodgings corresponds to at least one of the subset of temporal values. The action filter 265 determines 410 lodging preferences of the user based on actions performed by the user on the online system 100 or the third party system 120. For each of the subset of lodgings, the action filter 265 (or a model trained by the machine learning engine 275) generates 412 a likelihood that the user will select the lodging by matching the lodging preferences of the user with the corresponding one or more parameters of the lodging. The content engine 250 selects 414 a lodging of the set of lodgings based on the generated likelihoods. The content engine 250 provides 416 a content item for presentation on a client device 110 of the user. The content item includes the corresponding temporal value of the subset of temporal values of the selected lodging.

The content engine 250 may customize temporal values for a given lodging between different users. For example, the content engine 250 selects the selected lodging for another user of the online system 100. The content engine 250 determines a temporal value for the selected lodging based on user profile information or action information of the other user. Though the selected lodging is the same, the temporal values may vary between the user and the other user, e.g., because only one of the two users is a member of a loyalty program of the third party system 120 providing the selected lodging. Accordingly, the content engine 250 presents content items including different temporal values on the client devices 110 of the two users.

In some embodiments, the content engine 250 determines an incentive based on the lodging preferences of the user, where the user receives the incentive by booking the selected lodging. For example, the incentive may be reward points for a loyalty program of the third party system 120, monetary compensation, free lodging for a predetermined number of days or nights, consumable goods, or services. In one use case, the content engine 250 determines that the user often receives massages available at lodgings. Thus, the content engine 250 selects a one-hour massage voucher as the incentive. The content engine 250 provides information describing the incentive for presentation in the content item. Since the incentive is customized for the user, the user may be more likely to interact with the content item or book the lodging of the content item.

### V. Alternative Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, by an online system from a third party system, (i) a matrix of temporal values for a plurality of lodgings, each temporal value of the matrix of temporal values corresponding to at least a start date and an end date and (ii) one or more parameters describing the plurality of lodgings;
determining a target start date and a target end date for a user of the online system responsive to at least one action performed by the user;
determining a subset of temporal values by filtering the matrix of temporal values for temporal values having a corresponding start date and corresponding end date matching the target start date and the target end date, respectively;
determining a subset of lodgings of the plurality of lodgings, wherein each lodging of the subset of lodgings corresponds to at least one of the subset of temporal values;
determining lodging preferences of the user based on actions performed by the user on the online system or the third party system;
for each lodging of the subset of lodgings, generate a likelihood that the user will select the lodging by matching the lodging preferences of the user with the corresponding one or more parameters of the lodging;
selecting a lodging of the plurality of lodgings based on the generated likelihoods; and
providing a content item for presentation on a client device of the user, wherein the content item includes the corresponding temporal value of the subset of temporal values of the selected lodging.

2. The method of claim 1, wherein the likelihoods are generated using a model trained based at least in part on feature vectors derived from a plurality of actions performed by users of the online system, wherein the plurality of actions describe lodgings of the third party system that the users selected.

3. The method of claim 1, wherein the one or more parameters describe occupancy of the corresponding lodging, wherein determining the lodging preferences of the user based on the actions performed by the user on the online system comprises:
determining a number of family members of the user, wherein the selected lodging has an occupancy accommodates the number of family members.

4. The method of claim 1, wherein the one or more parameters describe amenities of the corresponding lodging, wherein determining the lodging preferences of the user based on the actions performed by the user on the online system comprises:
determining a set of amenities of a previous lodging selected by the user, wherein the likelihood that the user will select the lodging is proportional to a number of the set of amenities matching the amenities of the lodging.

5. The method of claim 1, wherein the matrix of temporal values includes a plurality of temporal values for the selected lodging, the plurality of temporal values corresponding to unique categories of users, and further comprising:
determining a category of the user, wherein the category of the user matches the category of the corresponding temporal value of the subset of temporal values of the selected lodging.

6. The method of claim 1, further comprising:
determining a score based at least in part on a temporal value of a previous lodging selected by the user and a probability that the user will select a subsequent lodging within a given period of time; and
receiving, by the online system from the third party system, a compensation proportional to the score based on the online system having provided the content item for presentation on the client device of the user

7. The method of claim 1, further comprising:
in response to determining a change in availability of the selected lodging, modifying the corresponding temporal value of the selected lodging; and
updating the content item to include the modified temporal value instead of the corresponding temporal value of the selected lodging.

8. The method of claim 1, further comprising:
determining an incentive based on the lodging preferences of the user, wherein the user receives the incentive by selecting the selected lodging; and
providing information describing the incentive for presentation in the content item.

9. The method of claim 1, wherein the at least one action indicates that the user selected transportation to a geographical location on a first date and transportation from the geographical location on a second date, wherein the target start date and the target end date are determined to match the first date and the second date, respectively, and wherein the corresponding one or more parameters of the selected lodging indicates that the selected lodging is located at the geographical location.

10. The method of claim 1, further comprising:
selecting the selected lodging for another user of the online system;
determining a temporal value corresponding to the selected lodging based on user information of the another user, the temporal value different than the corresponding temporal value of the subset of temporal values of the selected lodging; and
providing another content item for presentation on another client device of the another user, wherein the another content item includes the temporal value.

11. A non-transitory computer-readable storage medium storing instructions that when executed by a processor cause the processor to perform steps including:
receiving, by an online system from a third party system, (i) a matrix of temporal values for a plurality of lodgings, each temporal value of the matrix of temporal values corresponding to at least a start date and an end date and (ii) one or more parameters describing the plurality of lodgings;
determining a target start date and a target end date for a user of the online system responsive to at least one action performed by the user;
determining a subset of temporal values by filtering the matrix of temporal values for temporal values having a corresponding start date and corresponding end date matching the target start date and the target end date, respectively;
determining a subset of lodgings of the plurality of lodgings, wherein each lodging of the subset of lodgings corresponds to at least one of the subset of temporal values;
determining lodging preferences of the user based on actions performed by the user on the online system or the third party system;
for each lodging of the subset of lodgings, generate a likelihood that the user will select the lodging by matching the lodging preferences of the user with the corresponding one or more parameters of the lodging;
selecting a lodging of the plurality of lodgings based on the generated likelihoods; and
providing a content item for presentation on a client device of the user, wherein the content item includes the corresponding temporal value of the subset of temporal values of the selected lodging.

12. The non-transitory computer-readable storage medium of claim 11, wherein the likelihoods are generated using a model trained based at least in part on feature vectors derived from a plurality of actions performed by users of the online system, wherein the plurality of actions describe lodgings of the third party system that the users selected.

13. The non-transitory computer-readable storage medium of claim 11, wherein the one or more parameters describe occupancy of the corresponding lodging, wherein determining the lodging preferences of the user based on the actions performed by the user on the online system comprises:
determining a number of family members of the user, wherein the selected lodging has an occupancy accommodates the number of family members.

14. The non-transitory computer-readable storage medium of claim 11, wherein the one or more parameters describe amenities of the corresponding lodging, wherein determining the lodging preferences of the user based on the actions performed by the user on the online system comprises:
determining a set of amenities of a previous lodging selected by the user, wherein the likelihood that the user will select the lodging is proportional to a number of the set of amenities matching the amenities of the lodging.

15. The non-transitory computer-readable storage medium of claim 11, wherein the matrix of temporal values includes a plurality of temporal values for the selected lodging, the plurality of temporal values corresponding to unique categories of users, and wherein the instructions when executed further cause the processor to perform steps including:
determining a category of the user, wherein the category of the user matches the category of the corresponding temporal value of the subset of temporal values of the selected lodging.

16. The non-transitory computer-readable storage medium of claim 11, wherein the instructions when executed further cause the processor to perform steps including:
determining a score based at least in part on a temporal value of a previous lodging selected by the user and a probability that the user will select a subsequent lodging within a given period of time; and
receiving, by the online system from the third party system, a compensation proportional to the score based on the online system having provided the content item for presentation on the client device of the user

17. The non-transitory computer-readable storage medium of claim 11, wherein the instructions when executed further cause the processor to perform steps including:
in response to determining a change in availability of the selected lodging, modifying the corresponding temporal value of the selected lodging; and
updating the content item to include the modified temporal value instead of the corresponding temporal value of the selected lodging.

18. The non-transitory computer-readable storage medium of claim 11, wherein the instructions when executed further cause the processor to perform steps including:
determining an incentive based on the lodging preferences of the user, wherein the user receives the incentive by selecting the selected lodging; and
providing information describing the incentive for presentation in the content item.

19. The non-transitory computer-readable storage medium of claim 11, wherein the at least one action indicates that the user selected transportation to a geographical location on a first date and transportation from the geographical location on a second date, wherein the target start date and the target end date are determined to match the first date and the second date, respectively, and wherein the corresponding one or more parameters of the selected lodging indicates that the selected lodging is located at the geographical location.

20. The non-transitory computer-readable storage medium of claim 11, wherein the instructions when executed further cause the processor to perform steps including:
selecting the selected lodging for another user of the online system;
determining a temporal value corresponding to the selected lodging based on user information of the another user, the temporal value different than the corresponding temporal value of the subset of temporal values of the selected lodging; and
providing another content item for presentation on another client device of the another user, wherein the another content item includes the temporal value.
